(19) United States
(12) Patent Application Publication
(10) Pub. No.: US 2022/0327956 A1
(43) Pub. Date: Oct. 13, 2022

(54) LANGUAGE TEACHING MACHINE

(71) Applicant: Learning Squared, Inc., Sunnyvale, CA (US)

(72) Inventors: Andrew Butler, Sunnyvale, CA (US); Vera Blau-McCandliss, Stanford, CA (US); Carey Lee, Redwood City, CA (US)

(21) Appl. No.: 17/754,265

(22) PCT Filed: Sep. 10, 2020
(86) PCT No.: PCT/US2020/050113

§ 371 Date: Mar. 29, 2022

Related U.S. Application Data
(60) Provisional application No. 62/907,921, filed on Sep. 30, 2019.

(51) Int. Cl. G09B 19/04; G09B 19/06; G09B 5/06; G10L 15/187; G06F 3/01; G06V 40/20; G06V 40/16; G02B 27/01

(52) U.S. Cl. CPC G09B 19/04; G09B 19/06; G09B 5/06; G10L 15/187; G06F 3/017; G06V 40/28; G06V 40/171; G02B 27/0101; G02B 27/017; G02B 2027/0138; G02B 2027/014

(57) ABSTRACT

A set of machines functions as a language teaching lab. Configured by suitable hardware, software, accessories, or any suitable combination thereof, such a language teaching lab accesses multiple sources and types of data, such as video streams, audio streams, thermal imaging data, eye tracker data, breath anemometer data, biosensor data, accelerometer data, depth sensor data, or any suitable combination thereof. From the accessed data, the language teaching lab detects that the user is pronouncing, for example, a word, a phrase, or a sentence, and then causes presentation of a reference pronunciation of that word, phrase, or sentence. Other apparatus, systems, and methods are also disclosed.

### RELATED APPLICATION

This application claims the priority benefit of U.S. Provisional Patent Application No. 62/907,921, titled “LANGUAGE TEACHING MACHINE” and filed Sep. 30, 2019, which is incorporated herein by reference in its entirety.

### TECHNICAL FIELD

The subject matter disclosed herein generally relates to the technical field of special-purpose machines that facilitate teaching language, including software-configured computerized variants of such special-purpose machines and improvements to such variants, and to the technologies by which such special-purpose machines become improved compared to other special-purpose machines that facilitate teaching language. Specifically, the present disclosure addresses systems and methods to facilitate teaching one or more language skills, such as pronunciation of words, to one or more users (e.g., students, children, or any suitable combination thereof).

### BACKGROUND

A machine may be configured to teach language skills in the course of interacting with a user by presenting a graphical user interface (GUI) in which a language lesson is shown on a display screen and prompting the user to read aloud a word caused by the machine to appear in the GUI that shows the language lesson.

### BRIEF DESCRIPTION OF THE DRAWINGS

Some embodiments are illustrated by way of example and not limitation in the figures of the accompanying drawings.

FIG. 1 is a network diagram illustrating a network environment suitable for operating a server machine (e.g., a language teaching server machine), according to some example embodiments.

FIG. 2 is a block diagram illustrating components of a headset suitable for use with the server machine, according to some example embodiments.

FIG. 3 is a block diagram illustrating components of a device suitable for use with the server machine, according to some example embodiments.

FIG. 4 is a block diagram illustrating components of the server machine, according to some example embodiments.

FIG. 5-7 are flowcharts illustrating operations of the server machine in performing a method of teaching a language skill (e.g., pronunciation of a word), according to some example embodiments.

FIG. 8 is a block diagram illustrating components of a machine, according to some example embodiments, able to read instructions from a machine-readable medium and perform any one or more of the methodologies discussed herein.

### DETAILED DESCRIPTION

Example methods (e.g., algorithms) facilitate teaching language, and example systems (e.g., special-purpose machines configured by special-purpose software) are configured to facilitate teaching language. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided. In the following description, for purposes of explanation, numerous specific details are set forth to provide a thorough understanding of various example embodiments. It will be evident to one skilled in the art, however, that the present subject matter may be practiced without these specific details.

A set of one or more machines (e.g., computers or other devices) may be configured by suitable hardware and software to function collectively as a language teaching lab (e.g., a language teaching laboratory that is fully or partially wearable, portable, or otherwise mobile) for one or more users. Such a language teaching lab may operate based on one or more of various instructional principles, including, for example: that oral comprehension precedes written comprehension; that hearing phonemes occurs early (e.g., first) in learning a language; that auditory isolation from environmental noise (e.g., via one or more earphones) may facilitate learning a language; that oral repetition allows a user to compare a spoken phoneme to a memory of hearing that phoneme (e.g., in a feedback loop); and that mouth movements (e.g., mechanical motions by the user's mouth) are correlated to oral articulation. Accordingly, the one or more machines of the language teaching lab may be configured to access multiple sources and types of data (e.g., one or more video streams, an audio stream, thermal imaging data, eye tracker data, breath anemometer data, biosensor data, accelerometer data, depth sensor data, or any suitable combination thereof), detect from the accessed data that the user is pronouncing, for example, a word, a phrase, or a sentence, and then cause presentation of a reference (e.g., correct or standard) pronunciation of that word, phrase, or sentence. The presentation of the reference pronunciation may include playing audio of the reference pronunciation, playing video of an actor speaking the reference pronunciation, displaying an animated model of a mouth or face speaking the reference pronunciation, displaying such an animated model texture mapped with an image of the user's own mouth or face speaking the reference pronunciation, or any suitable combination thereof.

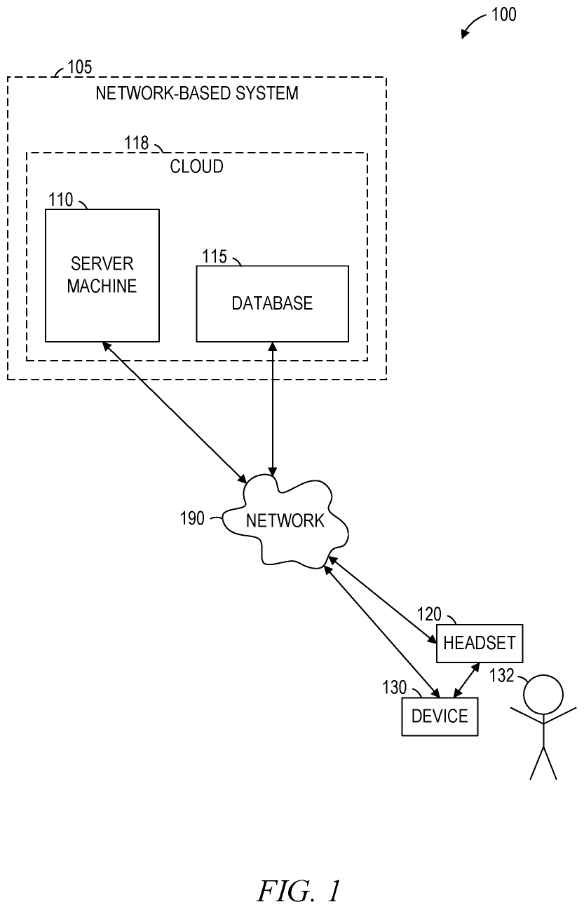

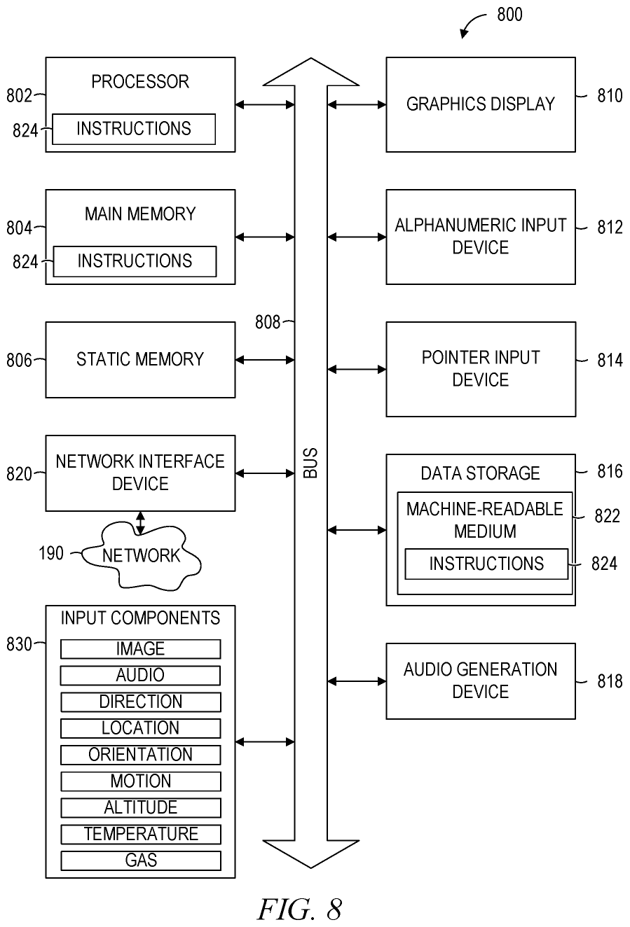

FIG. 1 is a network diagram illustrating a network environment 100 suitable for operating a server machine 110 (e.g., a language teaching server machine), according to some example embodiments. The network environment 100 includes the server machine 110, a database 115, a headset 120, and a device 130, all communicatively coupled to each other via a network 190. The server machine 110, with or without the database 115, may form all or part of a cloud 118 (e.g., a geographically distributed set of multiple machines configured to function as a single server), which may form all or part of a network-based system 105 (e.g., a cloud-based server system configured to provide one or more network-based services to the headset 120, the device 130, or both). The server machine 110, the database 115, the headset 120, and the device 130 may each be implemented in a special-purpose (e.g., specialized) computer system, in whole or in part, as described below with respect to FIG. 8.

Also shown in FIG. 1 is a user 132, who may be a person (e.g., a child, a student, a language learner, or any suitable combination thereof). More generally, the user 132 may be a human user (e.g., a human being), a machine user (e.g., a computer configured by a software program to interact with the device 130), or any suitable combination thereof (e.g., a human assisted by a machine or a machine supervised by a human). The user 132 is associated with the device 130 and may be a user of the device 130. For example, the device 130 may be a desktop computer, a vehicle computer, a home media system (e.g., a home theater system or other home entertainment system), a tablet computer, a navigational device, a portable media device, a smart phone, or a wearable device (e.g., a smart watch, smart glasses, smart clothing, or smart jewelry) belonging to the user 132. Likewise, the user 132 is associated with the headset 120 and may be a wearer of the headset 120. For example, the headset 120 may be worn on a head of the user 132 and operated therefrom. In some example embodiments, the headset 120 and the device are communicatively coupled to each other (e.g., independently of the network 190), such as via a wired local or personal network, a wireless networking connection, or any suitable combination thereof.

Any of the systems or machines (e g, databases, headsets, and devices) shown in FIG. 1 may be, include, or otherwise be implemented in a special-purpose (e.g., specialized or otherwise non-conventional and non-generic) computer that has been modified to perform one or more of the functions described herein for that system or machine (e.g., configured or programmed by special-purpose software, such as one or more software modules of a special-purpose application, operating system, firmware, middleware, or other software program). For example, a special-purpose computer system able to implement any one or more of the methodologies described herein is discussed below with respect to FIG. 8, and such a special-purpose computer may accordingly be a means for performing any one or more of the methodologies discussed herein. Within the technical field of such special-purpose computers, a special-purpose computer that has been specially modified (e.g., configured by special-purpose software) by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the systems or machines illustrated in FIG. 1 may be combined into a single system or machine, and the functions described herein for any single system or machine may be subdivided among multiple systems or machines.

The network 190 may be any network that enables communication between or among systems, machines, databases, and devices (e.g., between the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone service (POTS) network), a wireless data network (e.g., a WiFi network or WiMax network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

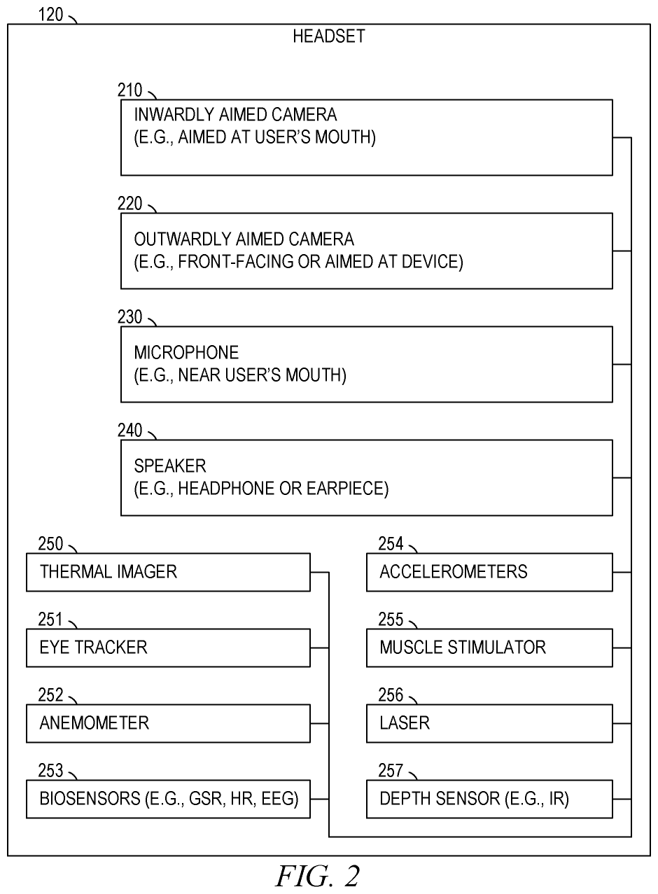

FIG. 2 is a block diagram illustrating components of the headset 120, according to some example embodiments. The headset 120 is shown as including an inwardly aimed camera 210 (e.g., pointed at, or otherwise oriented to view, the mouth of the user 132 when wearing the headset 120), an outwardly aimed camera 220 (e.g., pointed at, or otherwise oriented to view, an area in front of the user 132 when wearing the headset 120), a microphone 230 (e.g., pointed at or positioned near the mouth of the user 132), and a speaker 240 (e.g., an audio speaker, such as a headphone, earpiece, earbud, or any suitable combination thereof). Some example embodiments of the headset (e.g., for some speech therapy applications) omit the outwardly aimed camera 220 or ignore its video stream.

The headset 120 is also shown as including a thermal imager 250, an eye tracker 251 (e.g., pointed at, or otherwise oriented to view, one or both eyes of the user 132 when wearing the headset 120), an anemometer 252 (e.g., a breath anemometer pointed at or positioned near the mouth of the user 132 when wearing the headset 120), and a set of one or more biosensors 253 (e.g., positioned or otherwise configured to measure heartrate (HR), galvanic skin response (GSR), other skin conditions, an electroencephalogram (EEG), other brain states, or any suitable combination thereof, when the user 132 is wearing the headset 120).

In the example embodiments shown, the headset 120 further includes a set of one or more accelerometers 254 (e.g., positioned or otherwise configured to measure movements, for example, of the mouth of the user 132, the tongue of the user 132, the throat of the user 132, or any suitable combination thereof, when wearing the headset 120), a muscle stimulator 255 (e.g., a set of one or more neuromuscular electrical muscle stimulators positioned or otherwise configured to stimulate one or more muscles of the user 132 when wearing the headset 120), a laser 256 (e.g., a low-power or otherwise child-safe laser pointer aimed at, or otherwise oriented to emit a laser beam toward, an area in front of the user 132 when wearing the headset 120), and a depth sensor 257 (e.g., an infra-red or other type of depth sensor pointed at, or otherwise oriented to detect depth data in, an area in front of the user 132 when wearing the headset 120). As shown in FIG. 2, the various above-described components of the headset 120, or any sub-groupings thereof, are configured to communicate with each other (e.g., via a bus, shared memory, or a switch).

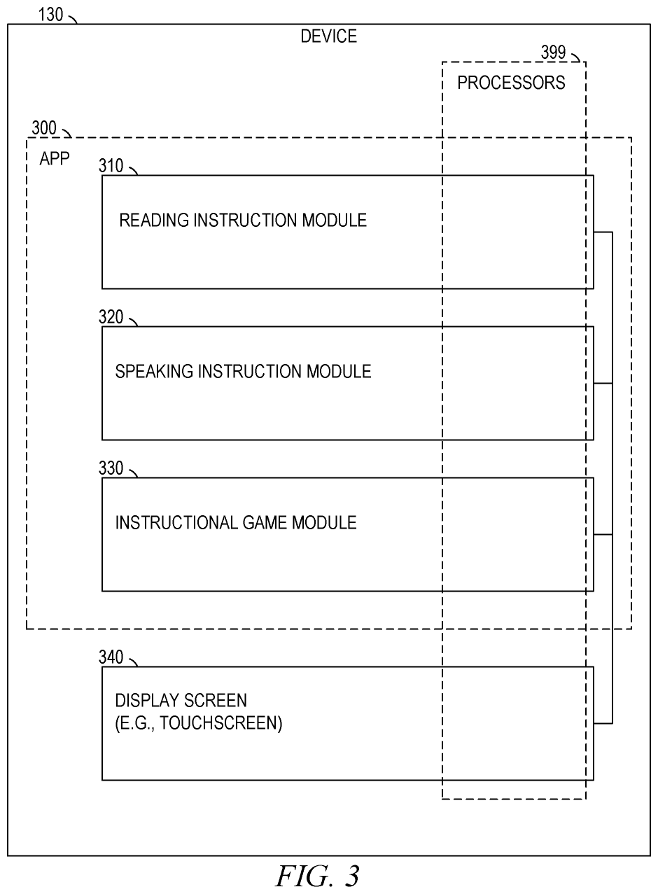

FIG. 3 is a block diagram illustrating components of the device 130, according to some example embodiments. The device 130 is shown as including a reading instruction module 310 (e.g., software-controlled hardware configured to interact with the user 132 in presenting one or more reading tutorials), a speaking instruction module 320 (e.g., software-controlled hardware configured to interact with the user 132 in presenting one or more speech tutorials), an instructional game module 330 (e.g., software-controlled hardware configured to interact with the user 132 in presenting one or more instructional games), and a display screen 340 (e.g., a touchscreen or other display screen). As shown in FIG. 3, the various above-described components of the device 130, or any sub-groupings thereof, are configured to communicate with each other (e.g., via a bus, shared memory, or a switch).

As shown in FIG. 3, the reading instruction module 310, the speaking instruction module 320, the instructional game module 330, or any combination thereof, may form all or part of an app 300 (e.g., a mobile app) that is stored (e.g., installed) on the device 130 (e.g., responsive to or otherwise as a result of data being received by the device 130 via the network 190). Furthermore, one or more processors 399 (e.g., hardware processors, digital processors, or any suitable combination thereof) may be included (e.g., temporarily or permanently) in the app 300, the reading instruction module 310, the speaking instruction module 320, the instructional game module 330, or any suitable combination thereof.

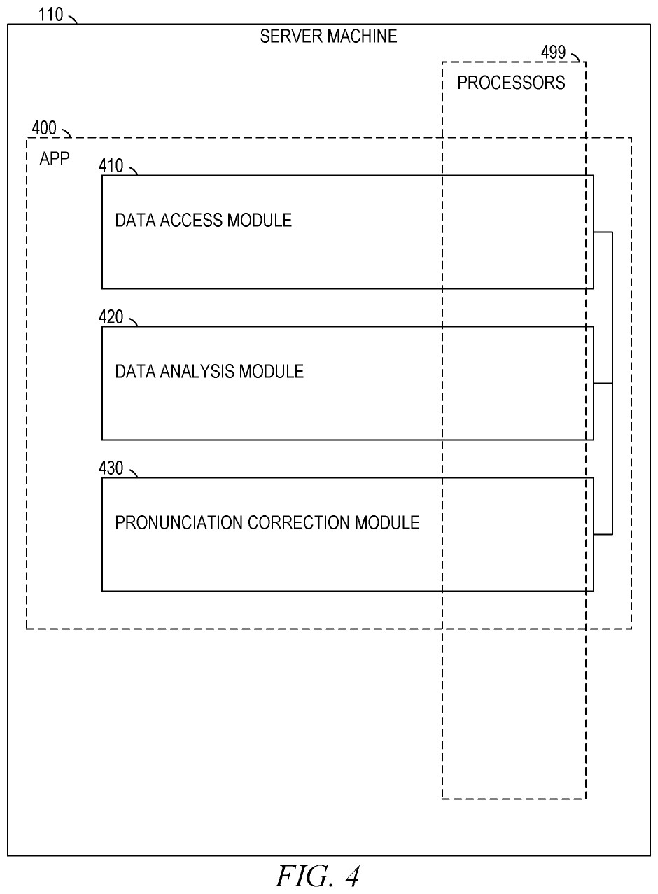

FIG. 4 is a block diagram illustrating components of the server machine 110, according to some example embodiments. The server machine 110 is shown as including a data access module 410, a data analysis module 420, and a pronunciation correction module 430, all configured to communicate with each other (e.g., via a bus, shared memory, or a switch).

As shown in FIG. 4, the data access module 410, the data analysis module 420, and the pronunciation correction module 430 may form all or part of an app 400 (e.g., a server-side app) that is stored (e.g., installed) on the server machine 110 (e.g., responsive to or otherwise as a result of data being received via the network 190). Furthermore, one or more processors 499 (e.g., hardware processors, digital processors, or any suitable combination thereof) may be included (e.g., temporarily or permanently) in the app 400, the data access module 410, the data analysis module 420, the pronunciation correction module 430, or any suitable combination thereof.

Any one or more of the components (e.g., modules) described herein may be implemented using hardware alone (e.g., one or more of the processors 399 or one or more of the processors 499, as appropriate) or a combination of hardware and software. For example, any component described herein may physically include an arrangement of one or more of the processors 399 or 499 (e.g., a subset of or among the processors 399 or 499), as appropriate, configured to perform the operations described herein for that component. As another example, any component described herein may include software, hardware, or both, that configure an arrangement of one or more of the processors 399 or 499, as appropriate, to perform the operations described herein for that component. Accordingly, different components described herein may include and configure different arrangements of the processors 399 or 499 at different points in time or a single arrangement of the processors 399 or 499 at different points in time. Each component (e.g., module) described herein is an example of a means for performing the operations described herein for that component. Moreover, any two or more components described herein may be combined into a single component, and the functions described herein for a single component may be subdivided among multiple components.

Furthermore, according to various example embodiments, components described herein as being implemented within a single system or machine (e.g., a single device) may be distributed across multiple systems or machines (e.g., multiple devices).

According to various example embodiments, the headset 120, the server machine 110, the device 130, or any suitable combination thereof, functions as a mobile language learning lab for the user 132. Such a language learning lab provides instruction in one or more language skills, practice exercises in those language skills, or both, to the user 132. This language learning lab may be enhanced by providing pronunciation analysis, contextual reading, motor-muscle memory recall analysis, auditory feedback, play-object identification, handwriting recognition, gesture recognition, eye-tracking, biometric analysis, or any suitable combination thereof.

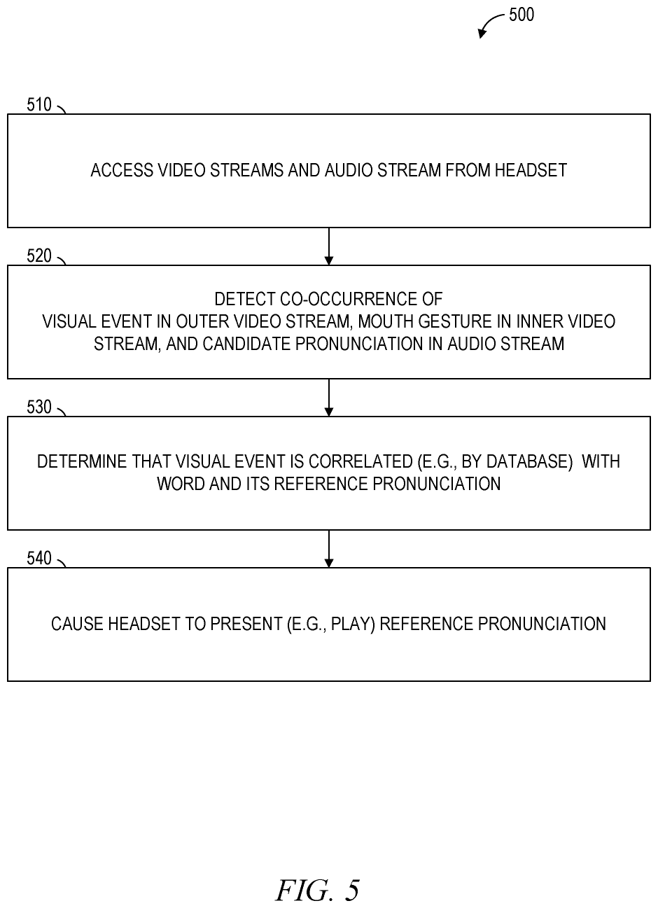

FIG. 5-7 are flowcharts illustrating operations of the server machine 110 in performing a method 500 of teaching a language skill (e.g., pronunciation of a word), according to some example embodiments. Operations in the method 500 may be performed by the server machine 110, the headset 120, the device 130, or any suitable combination thereof, using components (e.g., modules) described above with respect to FIGS. 2-4, using one or more processors (e.g., microprocessors or other hardware processors), or using any suitable combination thereof. As shown in FIG. 5, the method 500 includes operations 510, 520, 530, and 540.

In operation 510, the data access module 410 accesses two video streams and an audio stream. Specifically, the accessed streams are or include outer and inner video streams (e.g., an outer video stream and an inner video stream) and an audio stream that are all provided by the headset 120, which includes the outwardly aimed camera 220, the inwardly aimed camera 210, and the microphone 230. The outwardly aimed camera 220 of the headset 120 has an outward field-of-view that extends away from a wearer of the headset 120 (e.g., the user 132). The outwardly aimed camera 220 generates the outer video stream based on (e.g., using or from) the outward field-of-view. The inwardly aimed camera 210 of the headset 120 has an inward field-of-view that extends toward the wearer of the headset 120. The inwardly aimed camera 210 generates the inner video stream based on (e.g., using or from) the inward field-of-view. The audio stream is generated by the microphone 230. In example embodiments where the headset omits the outwardly aimed camera 220 or ignores the outer video stream (e.g., for some speech therapy applications), the data access module 410 similarly omits or ignores the outer video stream.

In operation 520, the data analysis module 420 detects, based on the streams accessed in operation 510, a co-occurrence of three things: a visual event in the outward field-of-view, a mouth gesture in the inward field-of-view, and a candidate pronunciation of a word. The visual event is represented in the accessed outer video stream; the mouth gesture is represented in the accessed inner video stream; and the candidate pronunciation is represented in the accessed audio stream. In example embodiments where the headset omits the outwardly aimed camera 220 or ignores the outer video stream (e.g., for some speech therapy applications), the data analysis module 420 detects a co-occurrence of two things: the mouth gesture in the inward field-of-view, and the candidate pronunciation of the word.

In operation 530, the pronunciation correction module 430 determines (e.g., by querying the database 115) that the visual event is correlated by the database 115 to the word and correlated to a reference pronunciation of the word. This determination may be performed by optically recognizing an appearance of the word (e.g., via optical character recognition) or an object (e.g., via shape recognition) associated with the word (e.g., by the database 115), within the outer field-of-view. In example embodiments where the headset omits the outwardly aimed camera 220 or ignores the outer video stream (e.g., for some speech therapy applications), the pronunciation correction module 430 determines (e.g., by querying the database 115), that the word is correlated to the reference pronunciation of the word.

In operation 540, the pronunciation correction module 430 causes (e.g., triggers, controls, or commands, for example, via remote signaling) the headset 120 to present the reference pronunciation of the word to the wearer (e.g., the user 132) in response to the detected co-occurrence of the visual event with the mouth gesture and with the candidate pronunciation of the word. In example embodiments where the headset omits the outwardly aimed camera 220 or ignores the outer video stream (e.g., for some speech therapy applications), the pronunciation correction module 430 causes the headset 120 to present the reference pronunciation of the word in response to the detected co-occurrence of the mouth gesture with the candidate pronunciation of the word.

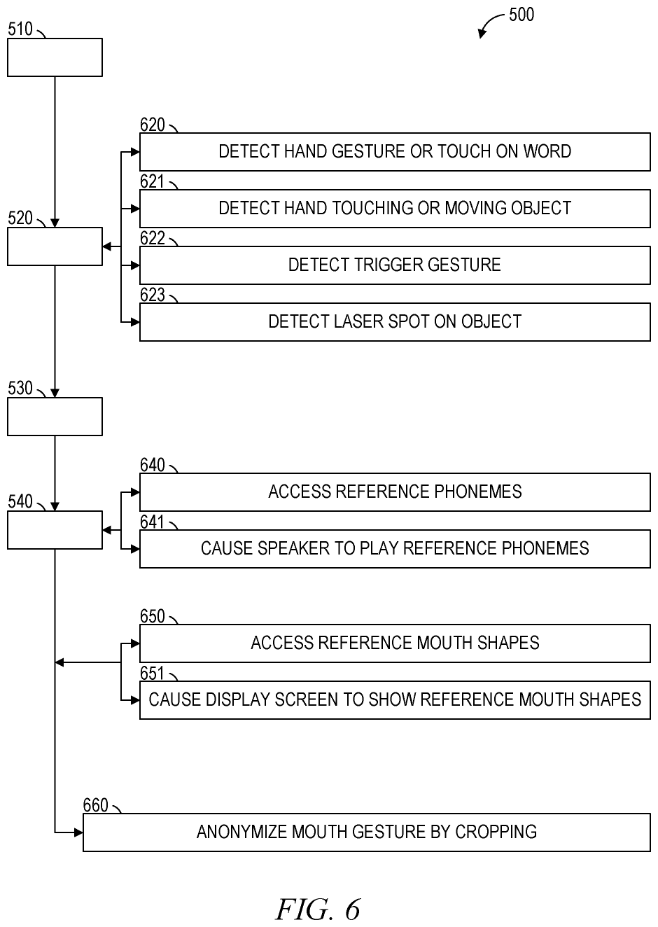

As shown in FIG. 6, in addition to any one or more of the operations previously described, the method 500 may include one or more of operations 620, 621, 622, 623, 640, 641, 650, 651, and 660. One or more of operations 620, 621, 622, and 623 may be performed as part (e.g., a precursor task, a subroutine, or a portion) of operation 520, in which the data analysis module 420 detects the three-way co-occurrence of the visual event in the outward field-of-view with the mouth gesture in the inward field-of-view and with the candidate pronunciation in the audio stream.

In operation 620, as all or part of detecting the visual event, the data analysis module 420 detects a hand gesture or a touch made by a hand of the user 132 occurring on or near a visible word (e.g., displayed by the device 130 within the outward field-of-view). The relevant threshold for nearness may be a distance sufficient to distinguish from the visible word from any other words visible in the outward field-of-view. For example, a detected hand gesture may point at the visible word or otherwise identify the visible word (e.g., to indicate a request for assistance in reading or pronouncing the visible word). As another example, a detected touch on the visible word may similarly identify the visible word (e.g., to indicate a request for assistance in reading or pronouncing the visible word). As a further example, the data analysis module 420 may detect a hand of the user 132 handwriting or tracing the visible word (e.g., to indicate a request for assistance in reading or pronouncing the visible word). As a still further example, the data analysis module 420 may detect a hand of the user 132 underlining or highlighting the visible word (e.g., with a pencil, a marker, a flashlight, or other suitable writing or highlighting instrument). Accordingly, the visual event detected in the outward field-of-view may include the hand of the user 132 handwriting the word, tracing the word, pointing at the word, touching the word, underlining the word, highlighting the word, or any suitable combination thereof. In response to the detected hand gesture or touch, the visible word identified by the hand gesture or touch may be treated as the word for which the candidate pronunciation is represented in the audio stream generated by the microphone 230.

In operation 621, as all or part of detecting the visual event, the data analysis module 420 detects that a hand of the user 132 is touching or moving a physical object that represents a word, where the physical object is visible within the outward field-of-view. For example, the physical object may be a model of an animal, such as a horse or a dog, or the physical object may be a toy or a block on which the word is printed or otherwise displayed. The moving of the physical object may be or include rotation in space within the outward field-of-view, translation in space within the outward field-of-view, or both. Accordingly, the visual event detected in the outward field-of-view may include the hand of the user 132 touching the physical object (e.g., the physical model), grasping the physical object, moving the physical object, rotating the physical object, or any suitable combination thereof. In response to the detected touching or moving of the physical object by the hand of the user 132, a word associated with the physical object (e.g., displayed by physical object or correlated with the physical object by the database 115) may be treated as the word for which the candidate pronunciation is represented in the audio stream generated by the microphone 230.

In operation 622, as all or part of detecting the visual event, the data analysis module 420 detects a trigger gesture (e.g., a triggering gesture) performed by a hand of the user 132 within the outward field-of-view. For example, the trigger gesture may be or include the performing of a predetermined hand shape, a predetermined pose by one or more fingers, a predetermined motion with the hand, or any suitable combination thereof. In response to the detected trigger gesture, the word for which the candidate pronunciation is represented in the audio stream generated by the microphone 230 may be identified for requesting assistance in reading or pronouncing that word (e.g., requesting correction of the candidate pronunciation represented in the audio stream generated by the microphone 230).

In operation 623, as all or part of detecting the visual event, the data analysis module 420 detects a laser spot (e.g., a bright spot of laser light) on a surface of a physical object visible in the outward field-of-view. For example, the headset 120 may include the outwardly aimed laser 256 (e.g., a laser pointer or other laser emitter) configured to designate an object in the outward field-of-view by causing a spot of laser light to appear on a surface of the object in the outward field-of-view, and the outwardly aimed camera 220 of the headset 120 may be configured to capture the spot of laser light and the designated object in the outward field-of-view. Accordingly, the visual event detected in the outward field-of-view may include the spot of laser light being caused to appear on the surface of the physical object in the outward field-of-view. In response to the detected spot of laser light appearing on the surface of the physical object, a word associated with the physical object (e.g., correlated with the physical object by the database 115) may be treated as the word for which the candidate pronunciation is represented in the audio stream generated by the microphone 230.

One or more of operations 640 and 641 may be performed as part (e.g., a precursor task, a subroutine, or a portion) of operation 540, in which the pronunciation correction module 430 causes the headset 120 to present the reference pronunciation of the word to the wearer (e.g., the user 132) of the headset 120.

In operation 640, the pronunciation correction module 430 accesses a set of reference phonemes included in the reference pronunciation of the word. The set of reference phonemes may be stored in the database 115 and accessed therefrom.

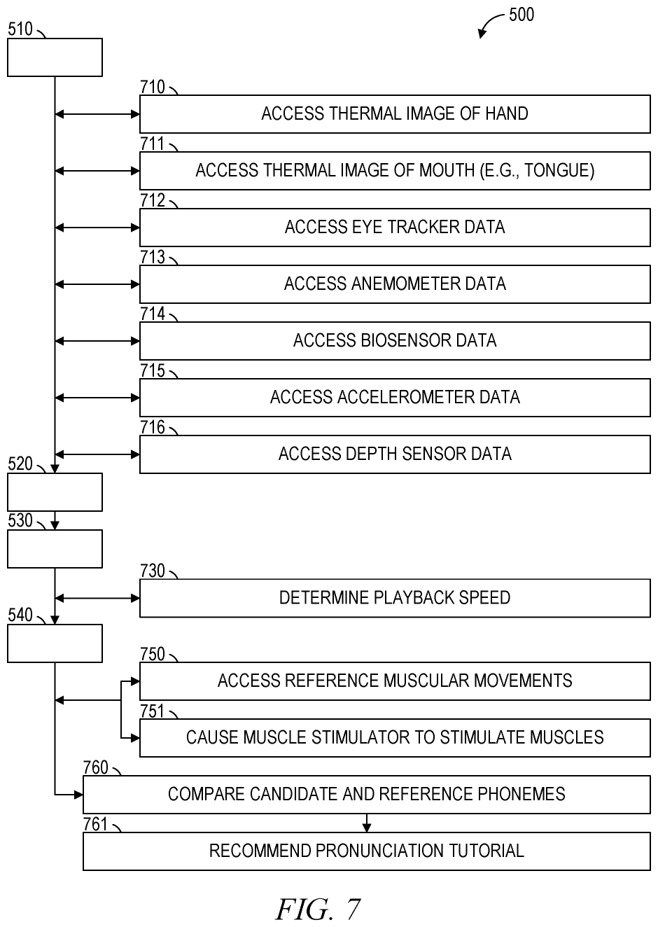

In operation 641, the pronunciation correction module 430 causes the speaker 240 in the headset 120 to play the set of reference phonemes accessed in operation 640. As discussed below with respect to FIG. 7, the speed at which the reference phonemes are played may vary and may be determined based on various factors. Returning to FIG. 6, one or more of operations 650, 651, and 660 may be performed at any point after operation 510, though the example embodiments illustrated indicate these operations being performed after operation 540.

In operation 650, the pronunciation correction module 430 accesses a reference set of mouth shapes (e.g., images or models of mouth shapes) each configured to speak a corresponding reference phoneme included in the reference pronunciation of the word. The reference set of mouth shapes may be stored in the database 115 and accessed therefrom. In some example embodiments, the pronunciation correction module 430 also accesses (e.g., from the database 115) an image of the user's own mouth or face for combining with (e.g., texture mapping onto, or morphing with) the reference set of mouth shapes.

In operation 651, the pronunciation correction module 430 causes a display screen (e.g., the display screen 340 of the device 130) to display the accessed reference set of mouth shapes to the wearer of the headset 120. In some example embodiments, the headset 120 and the display screen (e.g., the display screen 340) are caused to contemporaneously present the reference pronunciation (e.g., in audio form) of the word to the wearer of the headset 120 and display the accessed reference set of mouth shapes (e.g., in visual form on the display screen 340) to the wearer of the headset 120. In some example embodiments, the pronunciation correction module 430 combines (e.g., texture maps or morphs) the reference set of mouth shapes with an image of the user's own mouth or face and causes the display screen to present the resultant combination (e.g., contemporaneously with the reference pronunciation of the word).

In operation 660, the inwardly aimed camera 210 of the headset 120 has captured a mouth of the wearer of the headset 120 in the inward field-of-view, and the data analysis module 420 anonymizes the mouth gesture by cropping a portion of the inward field-of-view. The resulting cropped portion depicts the mouth gesture without depicting any eye of the wearer of the headset 120. This limited depiction may be helpful in situations where the privacy of the wearer (e.g., a young child) is important to maintain, such as where it would be beneficial to avoid capturing facial features (e.g., one or both eyes) usable by face-recognition software. In such example embodiments, the anonymized mouth gesture in the inward field-of-view is detected within the cropped portion of the inward field-of-view.

As shown in FIG. 7, in addition to any one or more of the operations previously described, the method 500 may include one or more of operations 710, 711, 712, 713, 714, 715, 716, 730, 750, 751, 760, and 761. One or more of operations 710-716 may be performed prior to operation 520, in which the data analysis module 420 detects the three-way co-occurrence of the visual event in the outward field-of-view with the mouth gesture in the inward field-of-view and with the candidate pronunciation in the audio stream. According to various example embodiments, the detection of the co-occurrence may be further based on one or more factors (e.g., conditions) detectable by data accessed in one or more of operations 710-716.

In operation 710, the data access module 410 accesses a thermal image of a hand of the wearer (e.g., the user 132) of the headset 120. For example, the outwardly aimed camera 220 may include a thermal imaging component (e.g., the thermal imager 250 or similar) configured to capture thermal images of objects within the outward field-of-view, or the thermal imaging component (e.g., the thermal imager 250) may be a separate component of the headset 120 and aimed to capture thermal images of objects in the outward field-of-view. Accordingly, the visual event in the outward field-of-view may be detected based on the thermal image of a hand of the wearer of the headset.

In operation 711, the data access module 410 accesses a thermal image of the mouth (e.g., depicting the tongue or otherwise indicating the shape of the tongue, the position of the tongue, or both) of the wearer (e.g., the user 132) of the headset 120. For example, the inwardly aimed camera 210 may include a thermal imaging component (e.g., the thermal imager 250 or similar) configured to capture thermal images of objects within the inward field-of-view, or the thermal imaging component (e.g., the thermal imager 250) may be a separate component of the headset 120 and aimed to capture thermal images of objects in the inward field-of-view. Accordingly, the mouth gesture in the inward field-of-view may be detected based on the thermal image of the mouth of the wearer of the headset 120.

In operation 712, the data access module 410 accesses eye tracker data that indicates an eye orientation of the wearer (e.g., the user 132) of the headset 120. For example, the headset 120 may further include an eye-tracking camera (e.g., the eye tracker 251) that may have a further field-of-view and be configured to capture the orientation of one or both eyes of the wearer in the further field-of-view. Accordingly, the data analysis module 420 may determine the direction in which one or both eyes of the wearer is looking based on the eye orientation indicated in the eye tracker data, and the visual event in the outward field-of-view may be detected based on the determined viewing direction in which the eye of the wearer is looking. For example, the determined viewing direction may be a basis for detecting the visual event (e.g., disambiguating or otherwise identifying the word for which the candidate pronunciation is represented in the audio stream generated by the microphone 230).

In operation 713, the data access module 410 accesses anemometer data that indicates one or more breath velocities of the wearer (e.g., the user 132) of the headset 120. For example, the headset 120 may include an anemometer (e.g., the anemometer 252) configured to detect a breath velocity of air entering or existing the mouth of the wearer of the headset 120. Accordingly, the causing of the headset 120 to present the reference pronunciation of the word in operation 540 may be based on the detected breath velocity of the wearer of the headset 120. For example, if the anemometer data indicates improper breathing in the candidate pronunciation of the word, the pronunciation correction module 430 may generate or access (e.g., from the database 115) an over-articulated reference pronunciation of the word or otherwise obtain an over-articulated reference pronunciation of the word and then cause the over-articulated pronunciation to be presented (e.g., played) to the wearer of the headset 120.

In operation 714, the data access module 410 accesses biosensor data that indicates one or more physiological conditions of the wearer (e.g., the user 132) of the headset 120. The biosensor data may be accessed from one or more biosensors (e.g., the biosensors 253) included in the headset 120 or communicatively coupled thereto. For example, one or more of the biosensors 253 may be positioned within the headset 120, communicatively coupled thereto, or otherwise configured to measure the heartrate of the wearer, a galvanic skin response of the wearer, one or more other skin conditions (e.g., temperature or elasticity) of the wearer, an electroencephalogram of the wearer, one or more brain states of the wearer, or any suitable combination thereof. Accordingly, the pronunciation correction module 430 may determine a speed at which the reference pronunciation of the word is to be played (e.g., to the wearer) based on the information indicated in the accessed biosensor data.

In operation 715, the data access module 410 accesses accelerometer data that indicates one or more muscle movements made by the wearer (e.g., the user 132) of the headset 120. The accelerometer data may be accessed from one or more accelerometers (e.g., the accelerometers 254) included in the headset 120 or communicatively coupled thereto. For example, one or more of the accelerometers 254 may be positioned within the headset 120, communicative the coupled thereto (e.g., included in a collar worn by the wearer of the headset 120), or otherwise configured to detect (e.g., by measurement) one or more muscle movements made during performance of the candidate pronunciation of the word by the wearer. Accordingly, the pronunciation correction module 430 may detect a pattern of muscular movements based on the accessed accelerometer data, and the causing of the headset 120 to present the reference pronunciation of the word in operation may be based on the detected pattern of muscular movements. For example, if the accelerometer data indicates an improper pattern of muscular movements in performing a candidate pronunciation of the word, the pronunciation correction module 430 may generate or access (e.g., from the database 115) an over-articulated reference pronunciation of the word or otherwise obtain an over-articulated reference pronunciation of the word and then cause the over-articulated pronunciation to be presented (e.g., played) to the wearer of the headset 120.

In operation 716, the data access module 410 accesses depth sensor data that indicates a distance to an object in the outward field-of-view. The depth sensor data may be accessed from one or more depth sensors (e.g., the depth sensor 257) included in the headset 120 or communicatively coupled thereto. For example, the depth sensor 257 may be a stereoscopic infrared depth sensor configured to detect distances to physical objects within the outward field-of-view. In some example situations, the outwardly aimed camera 220 of the headset 120 is configured to capture a hand of the wearer (e.g., the user 132) of the headset 120 designating a physical object in the outward field-of-view by touching the physical object at the distance detected by the depth sensor. Furthermore, the designated object may be correlated (e.g., by the database 115) to the word for which the candidate pronunciation is represented in the audio stream generated by the microphone 230, as well as correlated to the reference pronunciation of the word. Accordingly, the visual event in the outward field-of-view may be or include the hand of the wearer touching the designated object in the outward field-of-view.

In operation 730, the pronunciation correction module 430 determines a speed at which the reference pronunciation of the word is to be played back. For example, the pronunciation correction module 430 may determine a playback speed (e.g., 1×, 0.9×, 1.2×, or 0.5×) for the reference pronunciation, and the playback speed may be determined based on results from one or more of operations 712-715. As an example, the data analysis module 420 may detect that the wearer (e.g., the user 132) of the headset 120 exhibited a state of stress, fatigue, frustration, or other physiologically detectable state in performing the candidate pronunciation of the word, and this detection may be based on the eye tracker data accessed in operation 712, the anemometer data accessed in operation 713, the biosensor data accessed in operation 714, the accelerometer data accessed in operation 715, or any suitable combination thereof. Based on the detected state, the pronunciation correction module 430 may vary the playback speed of the reference pronunciation. Accordingly, the causing of the headset 120 to present the reference pronunciation of the word in operation 540 may be based on the playback speed determined in operation 730, and the reference pronunciation consequently may be played at that playback speed.

In certain example embodiments, the pronunciation correction module 430, in performing operation 730, determines that the speed at which the reference pronunciation is to be played back is zero or a null value for the speed. In particular, if the data analysis module 420 detects a sufficiently high state of stress, fatigue, frustration, or other physiologically detectable state in performing the candidate pronunciation of the word (e.g., transgressing beyond a threshold level), the pronunciation correction module 430 triggers a suggestion, recommendation, or other indication that the wearer (e.g., the user 132) take a rest break and resume performing candidate pronunciations of words after a period of recovery time. In such situations, the playback of the reference pronunciation of the word may be omitted or replaced with the triggered suggestion, recommendation, or other indication to take a rest break.

In operation 750, the pronunciation correction module 430 accesses a reference pattern of muscular movements configured to speak the reference pronunciation of the word. For example, the reference pattern of muscular movements may be stored in the database 115 and accessed therefrom.

In operation 751, the pronunciation correction module 430 causes one or more muscle stimulators (e.g., the muscle stimulator 255, which may be or include a neuromuscular electrical muscle stimulator) to stimulate a set of one or more muscles of the wearer (e.g., the user 132) of the headset 120. As an example, the muscle stimulator 255 may be included in the headset 120, communicatively coupled thereto (e.g., included in a collar that is communicatively coupled to the headset 120), or otherwise configured to stimulate a set of muscles of the wearer. Accordingly, the set of muscles may be caused (e.g., via neuromuscular electrical stimulation (NMES)) to move in accordance with the reference pattern of muscular movements. In some example embodiments, this causation of muscle motion is performed in conjunction with one or more repetitions of operation 540, in which the reference pronunciation of the word is caused to be presented to the wearer of the headset 120 (e.g., to assist the wearer in practicing how to articulate or otherwise perform the reference pronunciation of the word).

In operation 760, the pronunciation correction module 430 compares the candidate pronunciation of the word to the reference pronunciation of the word. This comparison may be made on a phoneme-by-phoneme basis, such that a sequentially first phoneme included in the candidate pronunciation is compared to a counterpart first phoneme included in the reference pronunciation, a sequentially second phoneme included in the candidate pronunciation is compared to a counterpart second phoneme included in the reference pronunciation, and so on.

In operation 761, based on the comparison performed in operation 760, the pronunciation correction module 430 recommends a pronunciation tutorial to the wearer (e.g., the user 132) of the headset 120. For example, the pronunciation correction module may cause presentation of an indication (e.g., a dialog box, an alert, an audio message, our any suitable combination thereof) that a pronunciation tutorial is being recommended to the wearer. In some example embodiment, the wearer can respond with an acceptance of the recommendation, and in response to the acceptance of the recommendation, the pronunciation correction module 430 may cause (e.g., command) the reading instruction module 310 to initiate presentation of a reading tutorial that teaches one or more reading skills used in reading the word, cause the speaking instruction module 320 to initiate a presentation of a speech tutorial that teaches one or more speaking skills used in pronouncing the word, cause the instructional game module 330 to initiate an instructional game that teaches one or more of the reading or speaking skills, or cause any suitable combination thereof.

According to various example embodiments, one or more of the methodologies described herein may facilitate teaching of language, or from another perspective, may facilitate learning of language. Moreover, one or more of the methodologies described herein may facilitate instructing the user 132 in hearing, practicing, and correcting proper pronunciations of phonemes, words, sentences, or any suitable combination thereof. Hence, one or more of the methodologies described herein may facilitate the teaching of language by facilitating a learner's learning of language, compared to capabilities of pre-existing systems and methods.

When these effects are considered in aggregate, one or more of the methodologies described herein may obviate a need for certain efforts or resources that otherwise would be involved in language instruction or language learning. Efforts expended by the user 132 in learning language skills, by a language teacher in teaching such language skills, or both, may be reduced by use of (e.g., reliance upon) a special-purpose machine that implements one or more of the methodologies described herein. Computing resources used by one or more systems or machines (e.g., within the network environment 100) may similarly be reduced (e.g., compared to systems or machines that lack the structures discussed herein or are otherwise unable to perform the functions discussed herein). Examples of such computing resources include processor cycles, network traffic, computational capacity, main memory usage, graphics rendering capacity, graphics memory usage, data storage capacity, power consumption, and cooling capacity.

FIG. 8 is a block diagram illustrating components of a machine 800, according to some example embodiments, able to read instructions 824 from a machine-readable medium 822 (e.g., a non-transitory machine-readable medium, a machine-readable storage medium, a computer-readable storage medium, or any suitable combination thereof) and perform any one or more of the methodologies discussed herein, in whole or in part. Specifically, FIG. 8 shows the machine 800 in the example form of a computer system (e.g., a computer) within which the instructions 824 (e.g., software, a program, an application, an applet, an app, or other executable code) for causing the machine 800 to perform any one or more of the methodologies discussed herein may be executed, in whole or in part.

In alternative embodiments, the machine 800 operates as a standalone device or may be communicatively coupled (e.g., networked) to other machines. In a networked deployment, the machine 800 may operate in the capacity of a server machine or a client machine in a server-client network environment, or as a peer machine in a distributed (e.g., peer-to-peer) network environment. The machine 800 may be a server computer, a client computer, a personal computer (PC), a tablet computer, a laptop computer, a netbook, a cellular telephone, a smart phone, a set-top box (STB), a personal digital assistant (PDA), a web appliance, a network router, a network switch, a network bridge, or any machine capable of executing the instructions 824, sequentially or otherwise, that specify actions to be taken by that machine. Further, while only a single machine is illustrated, the term “machine” shall also be taken to include any collection of machines that individually or jointly execute the instructions 824 to perform all or part of any one or more of the methodologies discussed herein.

The machine 800 includes a processor 802 (e.g., one or more central processing units (CPUs), one or more graphics processing units (GPUs), one or more digital signal processors (DSPs), one or more application specific integrated circuits (ASICs), one or more radio-frequency integrated circuits (RFICs), or any suitable combination thereof), a main memory 804, and a static memory 806, which are configured to communicate with each other via a bus 808. The processor 802 contains solid-state digital microcircuits (e.g., electronic, optical, or both) that are configurable, temporarily or permanently, by some or all of the instructions 824 such that the processor 802 is configurable to perform any one or more of the methodologies described herein, in whole or in part. For example, a set of one or more microcircuits of the processor 802 may be configurable to execute one or more modules (e.g., software modules) described herein. In some example embodiments, the processor 802 is a multicore CPU (e.g., a dual-core CPU, a quad-core CPU, an 8-core CPU, or a 128-core CPU) within which each of multiple cores behaves as a separate processor that is able to perform any one or more of the methodologies discussed herein, in whole or in part. Although the beneficial effects described herein may be provided by the machine 800 with at least the processor 802, these same beneficial effects may be provided by a different kind of machine that contains no processors (e.g., a purely mechanical system, a purely hydraulic system, or a hybrid mechanical-hydraulic system), if such a processor-less machine is configured to perform one or more of the methodologies described herein.

The machine 800 may further include a graphics display 810 (e.g., a plasma display panel (PDP), a light emitting diode (LED) display, a liquid crystal display (LCD), a projector, a cathode ray tube (CRT), or any other display capable of displaying graphics or video). The machine 800 may also include an alphanumeric input device 812 (e.g., a keyboard or keypad), a pointer input device 814 (e.g., a mouse, a touchpad, a touchscreen, a trackball, a joystick, a stylus, a motion sensor, an eye tracking device, a data glove, or other pointing instrument), a data storage 816, an audio generation device 818 (e.g., a sound card, an amplifier, a speaker, a headphone jack, or any suitable combination thereof), and a network interface device 820.

The data storage 816 (e.g., a data storage device) includes the machine-readable medium 822 (e.g., a tangible and non-transitory machine-readable storage medium) on which are stored the instructions 824 embodying any one or more of the methodologies or functions described herein. The instructions 824 may also reside, completely or at least partially, within the main memory 804, within the static memory 806, within the processor 802 (e.g., within the processor's cache memory), or any suitable combination thereof, before or during execution thereof by the machine 800. Accordingly, the main memory 804, the static memory 806, and the processor 802 may be considered machine-readable media (e.g., tangible and non-transitory machine-readable media). The instructions 824 may be transmitted or received over the network 190 via the network interface device 820. For example, the network interface device 820 may communicate the instructions 824 using any one or more transfer protocols (e.g., hypertext transfer protocol (HTTP)).

In some example embodiments, the machine 800 may be a portable computing device (e.g., a smart phone, a tablet computer, or a wearable device) and may have one or more additional input components 830 (e.g., sensors or gauges). Examples of such input components 830 include an image input component (e.g., one or more cameras), an audio input component (e.g., one or more microphones), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), a temperature input component (e.g., a thermometer), and a gas detection component (e.g., a gas sensor). Input data gathered by any one or more of these input components 830 may be accessible and available for use by any of the modules described herein (e.g., with suitable privacy notifications and protections, such as opt-in consent or opt-out consent, implemented in accordance with user preference, applicable regulations, or any suitable combination thereof).

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 822 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of carrying (e.g., storing or communicating) the instructions 824 for execution by the machine 800, such that the instructions 824, when executed by one or more processors of the machine 800 (e.g., processor 802), cause the machine 800 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible and non-transitory data repositories (e.g., data volumes) in the example form of a solid-state memory chip, an optical disc, a magnetic disc, or any suitable combination thereof.

A “non-transitory” machine-readable medium, as used herein, specifically excludes propagating signals per se. According to various example embodiments, the instructions 824 for execution by the machine 800 can be communicated via a carrier medium (e.g., a machine-readable carrier medium). Examples of such a carrier medium include a non-transient carrier medium (e.g., a non-transitory machine-readable storage medium, such as a solid-state memory that is physically movable from one place to another place) and a transient carrier medium (e.g., a carrier wave or other propagating signal that communicates the instructions 824).

Certain example embodiments are described herein as including modules. Modules may constitute software modules (e.g., code stored or otherwise embodied in a machine-readable medium or in a transmission medium), hardware modules, or any suitable combination thereof. A “hardware module” is a tangible (e.g., non-transitory) physical component (e.g., a set of one or more processors) capable of performing certain operations and may be configured or arranged in a certain physical manner. In various example embodiments, one or more computer systems or one or more hardware modules thereof may be configured by software (e.g., an application or portion thereof) as a hardware module that operates to perform operations described herein for that module.

In some example embodiments, a hardware module may be implemented mechanically, electronically, hydraulically, or any suitable combination thereof. For example, a hardware module may include dedicated circuitry or logic that is permanently configured to perform certain operations. A hardware module may be or include a special-purpose processor, such as a field programmable gate array (FPGA) or an ASIC. A hardware module may also include programmable logic or circuitry that is temporarily configured by software to perform certain operations. As an example, a hardware module may include software encompassed within a CPU or other programmable processor. It will be appreciated that the decision to implement a hardware module mechanically, hydraulically, in dedicated and permanently configured circuitry, or in temporarily configured circuitry (e.g., configured by software) may be driven by cost and time considerations.

Accordingly, the phrase “hardware module” should be understood to encompass a tangible entity that may be physically constructed, permanently configured (e.g., hardwired), or temporarily configured (e.g., programmed) to operate in a certain manner or to perform certain operations described herein. Furthermore, as used herein, the phrase “hardware-implemented module” refers to a hardware module. Considering example embodiments in which hardware modules are temporarily configured (e.g., programmed), each of the hardware modules need not be configured or instantiated at any one instance in time. For example, where a hardware module includes a CPU configured by software to become a special-purpose processor, the CPU may be configured as respectively different special-purpose processors (e.g., each included in a different hardware module) at different times. Software (e.g., a software module) may accordingly configure one or more processors, for example, to become or otherwise constitute a particular hardware module at one instance of time and to become or otherwise constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory (e.g., a memory device) to which it is communicatively coupled. A further hardware module may then, at a later time, access the memory to retrieve and process the stored output. Hardware modules may also initiate communications with input or output devices, and can operate on a resource (e.g., a collection of information from a computing resource).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module in which the hardware includes one or more processors. Accordingly, the operations described herein may be at least partially processor-implemented, hardware-implemented, or both, since a processor is an example of hardware, and at least some operations within any one or more of the methods discussed herein may be performed by one or more processor-implemented modules, hardware-implemented modules, or any suitable combination thereof.

Moreover, such one or more processors may perform operations in a “cloud computing” environment or as a service (e.g., within a “software as a service” (SaaS) implementation). For example, at least some operations within any one or more of the methods discussed herein may be performed by a group of computers (e.g., as examples of machines that include processors), with these operations being accessible via a network (e.g., the Internet) and via one or more appropriate interfaces (e.g., an application program interface (API)). The performance of certain operations may be distributed among the one or more processors, whether residing only within a single machine or deployed across a number of machines. In some example embodiments, the one or more processors or hardware modules (e.g., processor-implemented modules) may be located in a single geographic location (e.g., within a home environment, an office environment, or a server farm). In other example embodiments, the one or more processors or hardware modules may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and their functionality presented as separate components and functions in example configurations may be implemented as a combined structure or component with combined functions. Similarly, structures and functionality presented as a single component may be implemented as separate components and functions. These and other variations, modifications, additions, and improvements fall within the scope of the subject matter herein.

Some portions of the subject matter discussed herein may be presented in terms of algorithms or symbolic representations of operations on data stored as bits or binary digital signals within a memory (e.g., a computer memory or other machine memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “accessing,” “processing,” “detecting,” “computing,” “calculating,” “determining,” “generating,” “presenting,” “displaying,” or the like refer to actions or processes performable by a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The following enumerated descriptions describe various examples of methods, machine-readable media, and systems (e.g., machines, devices, or other apparatus) discussed herein.

A first example provides a method comprising:

accessing, by one or more processors of a machine, outer and inner video streams and an audio stream all provided by a headset that includes an outwardly aimed camera, an inwardly aimed camera, and a microphone, the outwardly aimed camera having an outward field-of-view extending away from a wearer of the headset and generating the outer video stream from the outward field-of-view, the inwardly aimed camera having an inward field-of-view extending toward the wearer and generating the inner video stream from the inward field-of-view;
detecting, by the one or more processors of the machine, a co-occurrence of a visual event in the outward field-of-view with a mouth gesture in the inward field-of-view and with a candidate pronunciation of a word, the visual event being represented in the outer video stream, the mouth gesture being represented in the inner video stream, the candidate pronunciation being represented in the audio stream;
determining, by the one or more processors of the machine, that the visual event is correlated by a database to the word and to a reference pronunciation of the word; and
causing, by the one or more processors of the machine, the headset to present the reference pronunciation of the word to the wearer in response to the detected co-occurrence of the visual event with the mouth gesture and with the candidate pronunciation of the word.

A second example provides a method according to the first example, wherein:

the causing of the headset to present the reference pronunciation of the word to the wearer of the headset includes:
accessing a set of reference phonemes included in the reference pronunciation of the word; and
causing a speaker in the headset to play the set of reference phonemes included in the reference pronunciation.

A third example provides a method according to the first example or the second example, wherein:

the outwardly aimed camera of the headset captures the word in the outward field-of-view; and
in the detected co-occurrence, the visual event in the outward field-of-view includes a hand performing at least one of: handwriting the word, tracing the word, pointing at the word, touching the word, underlining the word, or highlighting the word.

A fourth example provides a method according to any of the first through third examples, wherein:

the inwardly aimed camera of the headset captures a mouth of the wearer in the inward field-of-view; and
in the detected co-occurrence, the mouth gesture in the inward field-of-view includes the mouth of the wearer sequentially making a candidate set of mouth shapes each configured to speak a corresponding candidate phoneme included in the candidate pronunciation of the word.

A fifth example provides a method according to any of the first through fourth examples, wherein:

the inwardly aimed camera of the headset captures a mouth of the wearer in the inward field-of-view;
the method further comprises:
anonymizing the mouth gesture by cropping a portion of the inward field-of-view, the cropped portion depicting the mouth gesture without depicting any eye of the wearer of the headset; and wherein:
in the detected co-occurrence, the anonymized mouth gesture in the inward field-of-view is detected within the cropped portion of the inward field-of-view.

A sixth example provides a method according to any of the first through fifth examples, further comprising:

accessing a reference set of mouth shapes each configured to speak a corresponding reference phoneme included in the reference pronunciation of the word; and
causing a display screen to display the accessed reference set of mouth shapes to the wearer of the headset.

A seventh example provides a method according to the sixth example, wherein:

the headset and the display screen are caused to contemporaneously present the reference pronunciation of the word to the wearer of the headset and display the accessed reference set of mouth shapes to the wearer of the headset.

An eighth example provides a method according to any of the first through seventh examples, wherein:

the causing of the display screen to display the accessed reference set of mouth shapes includes combining the reference set of mouth shapes with an image that depicts a mouth of the wearer and causing the display screen to display a resultant combination of the image and the reference set of mouth shapes.

A ninth example provides a method according to any of the first through eighth examples, wherein:

the outwardly aimed camera of the headset captures a physical model that represents the word in the outward field-of-view; and
in the detected co-occurrence, the visual event in the outward field-of-view includes a hand performing at least one of: touching the physical model,
grasping the physical model, moving the physical model, or rotating the physical model.

A tenth example provides a method according to any of the first through ninth examples, wherein:

the outwardly aimed camera of the headset captures a hand of the wearer in the outward field-of-view; and
in the detected co-occurrence, the visual event in the outward field-of-view includes the hand performing a trigger gesture that indicates a correction request for correction of the candidate pronunciation.

An eleventh example provides a method according to the tenth example, wherein:

the causing of the headset to present the reference pronunciation of the word fulfills the request indicated by the trigger gesture performed by the hand of the wearer.

A twelfth example provides a method according to any of the first through eleventh examples, wherein:

the reference pronunciation presented in response to the detected co-occurrence of the visual event with the mouth gesture and with the candidate pronunciation of the word includes an over-articulated pronunciation of the word.

A thirteenth example provides a method according to any of the first through twelfth examples, wherein:

the outwardly aimed camera includes a thermal imaging component; and
in the detected co-occurrence, the visual event in the outward field-of-view is detected based on a thermal image of a hand of the wearer of the headset.

A fourteenth example provides a method according to any of the first through thirteenth examples, wherein:

the inwardly aimed camera includes a thermal imaging component; and
in the detected co-occurrence, the mouth gesture in the inward field-of-view is detected based on a thermal image of a tongue of the wearer of the headset.

A fifteenth example provides a method according to any of the first to fourteenth examples, wherein:

the headset further includes an eye-tracking camera having a further field-of-view and configured to capture an eye orientation of the wearer in the further field-of-view;
the method further comprises:
determining a direction (e.g., a viewing direction) in which the eye of the wearer is looking based on the eye orientation of the wearer; and wherein:
in the detected co-occurrence, the visual event in the outward field-of-view is detected based on the determined direction in which the eye of the wearer is looking.

A sixteenth example provides a method according to any of the first through fifteenth examples, wherein:

the headset further includes an anemometer configured to detect a breath velocity of the wearer of the headset; and
the causing of the headset to present the reference pronunciation of the word is based on the detected breath velocity of the wearer of the headset.

A seventeenth example provides a method according to any of the first through sixteenth examples, wherein:

the headset further includes a biosensor configured to detect a stress level of the wearer of the headset; and the method further comprises:
triggering presentation of an indication that the wearer of the headset take a rest break based on the detected stress level of the wearer.

An eighteenth example provides a method according to any of the first through seventeenth examples, wherein:

the headset is communicatively coupled to a biosensor configured to detect a skin condition of the wearer of the headset;
the method further comprises:
determining a playback speed at which the reference pronunciation is to be presented to the wearer based on the skin condition detected by the biosensor; and wherein:
the causing of the headset to present the reference pronunciation of the word includes causing the reference pronunciation to be played at the playback speed determined based on the skin condition.

A nineteenth example provides a method according to any of the first through eighteenth examples, wherein:

the headset is communicatively coupled to a biosensor configured to detect a heartrate of the wearer of the headset;
the method further comprises:
determining a playback speed at which the reference pronunciation is to be presented to the wearer based on the heartrate detected by the biosensor; and
wherein:
the causing of the headset to present the reference pronunciation of the word includes causing the reference pronunciation to be played at the playback speed determined based on the heartrate.

A twentieth example provides a method according to any of the first through nineteenth examples, wherein:

the headset is communicatively coupled to a biosensor configured to produce an electroencephalogram of the wearer of the headset;
the method further comprises:
determining a playback speed at which the reference pronunciation is to be presented to the wearer based on the electroencephalogram produced by the biosensor; and wherein:
the causing of the headset to present the reference pronunciation of the word includes causing the reference pronunciation to be played at the playback speed determined based on the electroencephalogram.

A twenty-first example provides a method according to any of the first through twentieth examples, wherein:

the headset is communicatively coupled to a set of accelerometers included in a collar worn by the wearer of the headset;
the method further comprises:
detecting a pattern of muscular movements based on accelerometer data generated by the set of accelerometers in the collar; and wherein:
the causing of the headset to present the reference pronunciation of the word is based on the detected pattern of muscular movements.

A twenty-second example provides a method according to the twenty-first example, wherein:

the headset is communicatively coupled to a set of neuromuscular electrical muscle stimulators included in the collar worn by the wearer of the headset;
the detected pattern of muscular movements is a candidate pattern of muscular movements made by the wearer in speaking the candidate pronunciation of the word; and
the method further comprises:
accessing a reference pattern of muscular movements configured to speak the reference pronunciation of the word; and
causing the neuromuscular electrical muscle stimulators in the collar to stimulate a set of muscles of the wearer based on the accessed reference pattern of muscular movements.

A twenty-third example provides a method according to any of the first through twenty-second examples, wherein:

the headset includes an outwardly aimed laser emitter configured to designate an object in the outward field-of-view by causing a spot of laser light to appear on a surface of the object in the outward field-of-view;
the outwardly aimed camera of the headset is configured to capture the spot of laser light and the designated object in the outward field-of-view;
the designated object is correlated by the database to the word and to the reference pronunciation of the word; and
in the detected co-occurrence, the visual event in the outward field-of-view includes the spot of laser light being caused to appear on the surface of the designated object in the outward field-of-view.

A twenty-fourth example provides a method according to any of the first through twenty-third examples, wherein:

the headset includes a stereoscopic depth sensor configured to detect a distance to an object in the outward field-of-view;
the outwardly aimed camera of the headset is configured to capture a hand of the wearer of the headset designating the object by touching the object at the distance in the outward field-of-view;
the designated object is correlated by the database to the word and to the reference pronunciation of the word; and
in the detected co-occurrence, the visual event in the outward field-of-view includes the hand of the wearer touching the designated object in the outward field-of-view.

A twenty-fifth example provides a method according to any of the first to twenty-fourth examples, further comprising:

performing a comparison of candidate phonemes in candidate pronunciation of the word to reference phonemes in the reference pronunciation of the word; and
recommending a pronunciation tutorial to the wearer of the headset based on the comparison of the candidate phonemes to the reference phonemes.

A twenty-sixth example provides a machine-readable medium (e.g., a non-transitory machine-readable storage medium) comprising instructions that, when executed by one or more processors of a machine, cause the machine to perform operations comprising:

accessing outward and inner video streams and an audio stream all provided by a headset that includes an outwardly aimed camera, an inwardly aimed camera, and a microphone, the outwardly aimed camera having an outward field-of-view extending away from a wearer of the headset and generating the outer video stream from the outward field-of-view, the inwardly aimed camera having an inward field-of-view extending toward the wearer and generating the inner video stream from the inward field-of-view;
detecting a co-occurrence of a visual event in the outward field-of-view with a mouth gesture in the inward field-of-view and with a candidate pronunciation of a word, the visual event being represented in the outer video stream, the mouth gesture being represented in the inner video stream, the candidate pronunciation being represented in the audio stream;
determining that the visual event is correlated by a database to the word and to a reference pronunciation of the word; and
causing the headset to present the reference pronunciation of the word to the wearer in response to the detected co-occurrence of the visual event with the mouth gesture and with the candidate pronunciation of the word.

A twenty-seventh example provides a system (e.g., a computer system) comprising:

one or more processors; and
a memory storing instructions that, when executed by at least one processor among the one or more processors, cause the system to perform operations comprising:
accessing outward and inner video streams and an audio stream all provided by a headset that includes an outwardly aimed camera, an inwardly aimed camera, and a microphone, the outwardly aimed camera having an outward field-of-view extending away from a wearer of the headset and generating the outer video stream from the outward field-of-view, the inwardly aimed camera having an inward field-of-view extending toward the wearer and generating the inner video stream from the inward field-of-view;
detecting a co-occurrence of a visual event in the outward field-of-view with a mouth gesture in the inward field-of-view and with a candidate pronunciation of a word, the visual event being represented in the outer video stream, the mouth gesture being represented in the inner video stream, the candidate pronunciation being represented in the audio stream;
determining that the visual event is correlated by a database to the word and to a reference pronunciation of the word; and
causing the headset to present the reference pronunciation of the word to the wearer in response to the detected co-occurrence of the visual event with the mouth gesture and with the candidate pronunciation of the word.

A twenty-eighth example provides a system (e.g., a computer system) comprising:

one or more processors; and
a memory storing instructions that, when executed by at least one processor among the one or more processors, cause the system to perform operations comprising:
accessing a video stream and an audio stream both provided by a headset that includes an inwardly aimed camera and a microphone, the inwardly aimed camera having an inward field-of-view extending toward a wearer of the headset and generating the video stream from the inward field-of-view;
detecting a co-occurrence of a mouth gesture in the inward field-of-view with a candidate pronunciation of a word, the mouth gesture being represented in the video stream, the candidate pronunciation being represented in the audio stream;

determining that the word is correlated by a database to a reference pronunciation of the word; and

causing the headset to present the reference pronunciation of the word to the wearer in response to the detected co-occurrence of the mouth gesture with the candidate pronunciation of the word.

A twenty-ninth example provides a carrier medium carrying machine-readable instructions for controlling a machine to carry out the operations (e.g., method operations) performed in any one of the previously described examples.

What is claimed is:

1. A method comprising:
accessing, by one or more processors of a machine, outer and inner video streams and an audio stream all provided by a headset that includes an outwardly aimed camera, an inwardly aimed camera, and a microphone, the outwardly aimed camera having an outward field-of-view extending away from a wearer of the headset and generating the outer video stream from the outward field-of-view, the inwardly aimed camera having an inward field-of-view extending toward the wearer and generating the inner video stream from the inward field-of-view;
detecting, by the one or more processors of the machine, a co-occurrence of a visual event in the outward field-of-view with a mouth gesture in the inward field-of-view and with a candidate pronunciation of a word, the visual event being represented in the outer video stream, the mouth gesture being represented in the inner video stream, the candidate pronunciation being represented in the audio stream;
determining, by the one or more processors of the machine, that the visual event is correlated by a database to the word and to a reference pronunciation of the word; and
causing, by the one or more processors of the machine, the headset to present the reference pronunciation of the word to the wearer in response to the detected co-occurrence of the visual event with the mouth gesture and with the candidate pronunciation of the word.

2. The method of claim 1, wherein:
the causing of the headset to present the reference pronunciation of the word to the wearer of the headset includes:
accessing a set of reference phonemes included in the reference pronunciation of the word; and
causing a speaker in the headset to play the set of reference phonemes included in the reference pronunciation.

3. The method of claim 1, wherein:
the outwardly aimed camera of the headset captures the word in the outward field-of-view; and
in the detected co-occurrence, the visual event in the outward field-of-view includes a hand performing at least one of: handwriting the word, tracing the word, pointing at the word, touching the word, underlining the word, or highlighting the word.

4. The method of claim 1, wherein:
the inwardly aimed camera of the headset captures a mouth of the wearer in the inward field-of-view; and
in the detected co-occurrence, the mouth gesture in the inward field-of-view includes the mouth of the wearer sequentially making a candidate set of mouth shapes each configured to speak a corresponding candidate phoneme included in the candidate pronunciation of the word.

5. The method of claim 1, wherein:
the inwardly aimed camera of the headset captures a mouth of the wearer in the inward field-of-view;
the method further comprises:
anonymizing the mouth gesture by cropping a portion of the inward field-of-view, the cropped portion depicting the mouth gesture without depicting any eye of the wearer of the headset; and wherein:
in the detected co-occurrence, the anonymized mouth gesture in the inward field-of-view is detected within the cropped portion of the inward field-of-view.

6. The method of claim 1, further comprising:
accessing a reference set of mouth shapes each configured to speak a corresponding reference phoneme included in the reference pronunciation of the word; and
causing a display screen to display the accessed reference set of mouth shapes to the wearer of the headset.

7. The method of claim 6, wherein:
the headset and the display screen are caused to contemporaneously present the reference pronunciation of the word to the wearer of the headset and display the accessed reference set of mouth shapes to the wearer of the headset.

8. The method of claim 6, wherein:
the causing of the display screen to display the accessed reference set of mouth shapes includes combining the reference set of mouth shapes with an image that depicts a mouth of the wearer and causing the display screen to display a resultant combination of the image and the reference set of mouth shapes.

9. The method of claim 1, wherein:
the outwardly aimed camera of the headset captures a physical model that represents the word in the outward field-of-view; and
in the detected co-occurrence, the visual event in the outward field-of-view includes a hand performing at least one of: touching the physical model, grasping the physical model, moving the physical model, or rotating the physical model.

10. The method of claim 1, wherein:
the outwardly aimed camera of the headset captures a hand of the wearer in the outward field-of-view; and
in the detected co-occurrence, the visual event in the outward field-of-view includes the hand performing a trigger gesture that indicates a correction request for correction of the candidate pronunciation.

11. The method of claim 10, wherein:
the causing of the headset to present the reference pronunciation of the word fulfills the request indicated by the trigger gesture performed by the hand of the wearer.

12. The method of claim 1, wherein:
the reference pronunciation presented in response to the detected co-occurrence of the visual event with the mouth gesture and with the candidate pronunciation of the word includes an over-articulated pronunciation of the word.

13. The method of claim 1, wherein:
the outwardly aimed camera includes a thermal imaging component; and
in the detected co-occurrence, the visual event in the outward field-of-view is detected based on a thermal image of a hand of the wearer of the headset.

14. The method of claim 1, wherein:
the inwardly aimed camera includes a thermal imaging component; and
in the detected co-occurrence, the mouth gesture in the inward field-of-view is detected based on a thermal image of a tongue of the wearer of the headset.

15. The method of claim 1, wherein:
the headset further includes an eye-tracking camera having a further field-of-view and configured to capture an eye orientation of the wearer in the further field-of-view;
the method further comprises:
determining a direction in which the eye of the wearer is looking based on the eye orientation of the wearer; and wherein:
in the detected co-occurrence, the visual event in the outward field-of-view is detected based on the determined direction in which the eye of the wearer is looking.

16. The method of claim 1, wherein:
the headset further includes an anemometer configured to detect a breath velocity of the wearer of the headset; and
the causing of the headset to present the reference pronunciation of the word is based on the detected breath velocity of the wearer of the headset.

17. The method of claim 1, wherein:
the headset further includes a biosensor configured to detect a stress level of the wearer of the headset; and
the method further comprises:
triggering presentation of an indication that the wearer of the headset take a rest break based on the detected stress level of the wearer.

18. The method of claim 1, wherein:
the headset is communicatively coupled to a biosensor configured to detect a skin condition of the wearer of the headset;
the method further comprises:
determining a playback speed at which the reference pronunciation is to be presented to the wearer based on the skin condition detected by the biosensor; and wherein:
the causing of the headset to present the reference pronunciation of the word includes causing the reference pronunciation to be played at the playback speed determined based on the skin condition.

19. The method of claim 1, wherein:
the headset is communicatively coupled to a biosensor configured to detect a heartrate of the wearer of the headset;
the method further comprises:
determining a playback speed at which the reference pronunciation is to be presented to the wearer based on the heartrate detected by the biosensor; and wherein:
the causing of the headset to present the reference pronunciation of the word includes causing the reference pronunciation to be played at the playback speed determined based on the heartrate.

20. The method of claim 1, wherein:
the headset is communicatively coupled to a biosensor configured to produce an electroencephalogram of the wearer of the headset;
the method further comprises:
determining a playback speed at which the reference pronunciation is to be presented to the wearer based on the electroencephalogram produced by the biosensor; and wherein:
the causing of the headset to present the reference pronunciation of the word includes causing the reference pronunciation to be played at the playback speed determined based on the electroencephalogram.

21. The method of claim 1, wherein:
the headset is communicatively coupled to a set of accelerometers included in a collar worn by the wearer of the headset;
the method further comprises:
detecting a pattern of muscular movements based on accelerometer data generated by the set of accelerometers in the collar; and wherein:
the causing of the headset to present the reference pronunciation of the word is based on the detected pattern of muscular movements.

22. The method of claim 21, wherein:
the headset is communicatively coupled to a set of neuromuscular electrical muscle stimulators included in the collar worn by the wearer of the headset;
the detected pattern of muscular movements is a candidate pattern of muscular movements made by the wearer in speaking the candidate pronunciation of the word; and
the method further comprises:
accessing a reference pattern of muscular movements configured to speak the reference pronunciation of the word; and
causing the neuromuscular electrical muscle stimulators in the collar to stimulate a set of muscles of the wearer based on the accessed reference pattern of muscular movements.

23. The method of claim 1, wherein:
the headset includes an outwardly aimed laser emitter configured to designate an object in the outward field-of-view by causing a spot of laser light to appear on a surface of the object in the outward field-of-view;
the outwardly aimed camera of the headset is configured to capture the spot of laser light and the designated object in the outward field-of-view;
the designated object is correlated by the database to the word and to the reference pronunciation of the word; and
in the detected co-occurrence, the visual event in the outward field-of-view includes the spot of laser light being caused to appear on the surface of the designated object in the outward field-of-view.

24. The method of claim 1, wherein:
the headset includes a stereoscopic depth sensor configured to detect a distance to an object in the outward field-of-view;
the outwardly aimed camera of the headset is configured to capture a hand of the wearer of the headset designating the object by touching the object at the distance in the outward field-of-view;
the designated object is correlated by the database to the word and to the reference pronunciation of the word; and
in the detected co-occurrence, the visual event in the outward field-of-view includes the hand of the wearer touching the designated object in the outward field-of-view.

25. The method of claim 1, further comprising:
performing a comparison of candidate phonemes in candidate pronunciation of the word to reference phonemes in the reference pronunciation of the word; and
recommending a pronunciation tutorial to the wearer of the headset based on the comparison of the candidate phonemes to the reference phonemes.

26. A machine-readable medium comprising instructions that, when executed by one or more processors of a machine, cause the machine to perform operations comprising:
accessing outward and inner video streams and an audio stream all provided by a headset that includes an outwardly aimed camera, an inwardly aimed camera, and a microphone, the outwardly aimed camera having an outward field-of-view extending away from a wearer of the headset and generating the outer video stream from the outward field-of-view, the inwardly aimed camera having an inward field-of-view extending toward the wearer and generating the inner video stream from the inward field-of-view;
detecting a co-occurrence of a visual event in the outward field-of-view with a mouth gesture in the inward field-of-view and with a candidate pronunciation of a word, the visual event being represented in the outer video stream, the mouth gesture being represented in the inner video stream, the candidate pronunciation being represented in the audio stream;
determining that the visual event is correlated by a database to the word and to a reference pronunciation of the word; and
causing the headset to present the reference pronunciation of the word to the wearer in response to the detected co-occurrence of the visual event with the mouth gesture and with the candidate pronunciation of the word.

27. A system comprising:
one or more processors; and
a memory storing instructions that, when executed by at least one processor among the one or more processors, cause the system to perform operations comprising:
accessing outward and inner video streams and an audio stream all provided by a headset that includes an outwardly aimed camera, an inwardly aimed camera, and a microphone, the outwardly aimed camera having an outward field-of-view extending away from a wearer of the headset and generating the outer video stream from the outward field-of-view, the inwardly aimed camera having an inward field-of-view extending toward the wearer and generating the inner video stream from the inward field-of-view;
detecting a co-occurrence of a visual event in the outward field-of-view with a mouth gesture in the inward field-of-view and with a candidate pronunciation of a word, the visual event being represented in the outer video stream, the mouth gesture being represented in the inner video stream, the candidate pronunciation being represented in the audio stream;
determining that the visual event is correlated by a database to the word and to a reference pronunciation of the word; and
causing the headset to present the reference pronunciation of the word to the wearer in response to the detected co-occurrence of the visual event with the mouth gesture and with the candidate pronunciation of the word.

28. A system comprising:
one or more processors; and
a memory storing instructions that, when executed by at least one processor among the one or more processors, cause the system to perform operations comprising:
accessing a video stream and an audio stream both provided by a headset that includes an inwardly aimed camera and a microphone, the inwardly aimed camera having an inward field-of-view extending toward a wearer of the headset and generating the video stream from the inward field-of-view;
detecting a co-occurrence of a mouth gesture in the inward field-of-view with a candidate pronunciation of a word, the mouth gesture being represented in the video stream, the candidate pronunciation being represented in the audio stream;
determining that the word is correlated by a database to a reference pronunciation of the word; and
causing the headset to present the reference pronunciation of the word to the wearer in response to the detected co-occurrence of the mouth gesture with the candidate pronunciation of the word.
